(19) United States
(12) Patent Application Publication
(10) Pub. No.: US 2010/0277767 A1
(43) Pub. Date: Nov. 4, 2010

(54) PROFIT BASED LAYOUTS

(76) Inventor: John Henry Klippenstein, Roberts Creek (CA)

Correspondence Address: EASTMAN KODAK COMPANY;PATENT LEGAL STAFF, 343 STATE STREET, ROCHESTER, NY, 14650-2201, US

(21) Appl. No.: 12/433,121

(22) Filed: Apr. 30, 2009

(51) Int. Cl. G06K 15/00

(52) U.S. Cl. 358/1.18

(57) ABSTRACT

A system (1) and method for arranging a plurality of items (9) on a sheet (7) is described. A combination of simple (22) and complex (53) layout algorithms are used to efficiently search for a layout with maximum profit. Different layouts are considered based on selecting sets of items from a queue of items.

### CROSS REFERENCE TO RELATED APPLICATIONS

Reference is made to commonly-assigned co-pending U.S. patent application Ser. No. 12/038,013 filed Feb. 27, 2008, entitled AUTOMATED LAYOUT, by Klippenstein, and commonly-assigned co-pending U.S. patent application Ser. No. 11/849,534, filed Sep. 4, 2007; Publication No. 2009/0059298 published Mar. 5, 2009, and entitled SIMULTANEOUS PRINTING OF PAGES FROM MULTIPLE JOBS, by Huenemann the disclosures of which are incorporated herein.

### FIELD OF THE INVENTION

The present invention pertains to producing layouts from a collection of items and in particular to methods and systems for automatically producing said layouts.

### BACKGROUND OF THE INVENTION

Printing shops commonly produce layouts for printing press sheets that include items from multiple jobs. The prior art teaches various approaches for producing such layouts. Some approaches employ simple but fast algorithms. These algorithms tend to find reasonably efficient layouts but they are typically not the most efficient layouts that can be identified. Other approaches employ more complex layout algorithms that have a greater chance of identifying more efficient layouts.

One example of a very simple layout algorithm is a grid algorithm that segments a sheet into one or more uniform grids. The size of a grid cell may be chosen to fit at least one item from a job queue. This algorithm is amongst the fastest when a small number of items, and therefore grid cell sizes, are selected. With current computing power, thousands of layouts per second can be generated when employing a small number of grids.

Unused sheet space can occur, for example, if the grid size doesn't align with the sheet size or if the placed items do not have the same size as the grid cell. For a queue with many items of varying size and desired quantities, this algorithm may require computing many possible layouts before finding one that facilitates adequate pressrun efficiency. Further, since the algorithm may not be able to consider an arbitrary set of items from the queue, it may be unable to find a preferred layout for the pressrun.

By pressrun efficiency, we mean the degree of efficiency in the utilization of the sheet's usable area and the consumption of press resources (e.g. paper stock, ink, time). In other words, an efficient pressrun is one with an efficient utilization of the sheet and with little or no waste from the pressrun (e.g. minimal extras of each item included in the layout). Optionally, pressrun efficiency can include a value weighting for the items and can include the efficiency of downstream processing of the pressrun sheets (e.g. finishing, billing and delivery tasks).

Another example of a simple layout algorithm is a Best-Fit Decreasing Height (BFDH) algorithm which segments a sheet area into levels and populates the sheet level-wise with items from a queue such that each item placed has the same or lesser height than all items previously placed on that level. This algorithm can require somewhat more time per layout but has the advantage of accommodating a larger variety of item sizes and desired quantities.

Another example of a simple layout algorithm is the algorithm disclosed by in the above-referenced U.S. patent application Ser. No. 11/849,534. This algorithm is similar to BFDH in that it employs levels and is able to identify efficient sheet layouts for reasonably large queues by attempting layouts at the rate of approximately 60 layouts per second.

An example of a more complex layout algorithm is the algorithm disclosed in commonly-assigned copending U.S. patent application Ser. No. 12/038,013 filed Feb. 27, 2008 (Klippenstein). This algorithm searches for an optimal layout of an ordered set of items by using a multi-phased build tree approach. One part of the algorithm discloses attempting layouts for a subset of an ordered set of items using build trees. Another part of the algorithm discloses searching the neighborhood of an unsuccessful build tree in an attempt to find one that fits the sheet.

This algorithm was found to produce highly efficient layouts for an ordered set of items in about 5 seconds for most ordered set of items. Without the neighborhood searching part enabled, the basic build tree algorithm tends to identify somewhat less efficient layouts but with approximately an order of magnitude reduction in time required (e.g. a few tenths of a second). One limitation of this algorithm is that it requires an ordered set of items as a starting point. For a queue with many items of varying sizes and desired quantities, many starting points are possible and thus a significant amount of time would be required to find a preferred layout.

One can categorize the algorithms in various ways. In one scheme, based on computing resource consumption, a complex layout algorithm can be defined to consume at least an order of magnitude more resources than a simple layout algorithm. Since resource consumption can vary on a continuum, one can define complex layout algorithms relative to the most complex of the simple layout algorithms considered.

For example, if the algorithm of U.S. patent application Ser. No. 11/849,534 is identified as the most complex of the simple layout algorithms, the algorithm of U.S. patent application Ser. No. 12/038,013 can be classified as a complex layout algorithm. The choice of the cutoff point for simple layout algorithms can vary somewhat according to computing power available and print shop preferences.

Since the trend for pressrun durations is shrinking from hours to minutes, searching for an optimal layout should practically be limited to a small fraction of the pressrun time (e.g. 1-2 minutes). This allows time to consider jobs that arrive just before press time, which may facilitate more efficient pressruns. It also allows the print shop to re-prioritize jobs as late as possible to provide additional flexibility.

A need still exists to identify a preferred layout for a pressrun from a queue comprising an arbitrary number of items of varying sizes and desired quantities. The preferred layout should produce an efficient pressrun and be identified within a small fraction of the time required to perform the pressrun. Utilization of different layout algorithms with different strengths and weaknesses may be advantageous in searching for a preferred layout within practical time constraints.

### SUMMARY OF THE INVENTION

The present invention provides a system and method for arranging a plurality of items on a sheet. According to one aspect of the invention, information about a printing sheet and a queue of items is obtained. Information for each item includes dimensions and a desired quantity. Simple layout algorithms can be used to generate a first set of candidate layouts for the sheet based on various combinations of items from the queue. Simple algorithms are preferred because they complete quickly. However, a layout attempt with a simple layout algorithm may or may not produce a layout.

According to another aspect of the invention, a pressrun is identified for each candidate layout produced. A pressrun includes the layout and a press run-length required to produce at least the desired quantity of each item.

According to another aspect of the invention, a profit for each candidate pressrun can be produced so that pressruns may be compared. The pressrun with the highest profit is identified.

According to another aspect of the invention, a search for item-lists having the potential to produce higher profit pressruns can be performed. An item-list includes a collection of items, including one or more copies of an item from the queue, and a run-length for the sheet but lacks a successful layout to form a pressrun.

According to one embodiment, searching for an item-list can comprise searching amongst neighbors of a home item-set, comprising single copies of items from the queue. In preferred embodiments, home item-sets can be identified from candidate pressruns and neighbor item-sets can be identified by adding and/or removing items from the home item-set.

According to another aspect of the invention, when a simple layout algorithm fails to produce a successful layout, an item-list may be identified that would produce a higher profit pressrun if a layout was possible for that item-list. Such an item-list can be recorded so that a subset of such hopeful item-lists can be evaluated using a complex layout algorithm that has a greater chance of finding a successful layout.

According to another aspect of the invention, dual-feasible functions can be used to determine whether a layout is possible using a complex layout algorithm.

According to another aspect of the invention, the set of hopeful item-lists can be ranked using a function that provides a tradeoff between layout value and layout difficulty. Layout attempts for highly ranked hopeful item-lists can be performed first.

These and other aspects of the present invention are illustrated in the detailed description of the invention.

### BRIEF DESCRIPTION OF THE DRAWINGS

FIG. 1 is a diagram illustrating an exemplary system for producing a layout for a pressrun.

FIG. 2 is a flowchart diagram illustrating an exemplary method for identifying a preferred pressrun according to the present invention.

FIG. 3 is a flowchart diagram illustrating an exemplary method for identifying a first preferred pressrun according to the present invention.

FIG. 4 is a flowchart diagram illustrating an exemplary method for searching for higher-profit pressruns according to the present invention.

FIG. 5 is a flowchart diagram illustrating an exemplary method for attempting layouts for hopeful item-lists according to the present invention.

FIGS. 6A-6K are diagrams illustrating exemplary layouts generated according to the present invention.

### DETAILED DESCRIPTION OF THE INVENTION

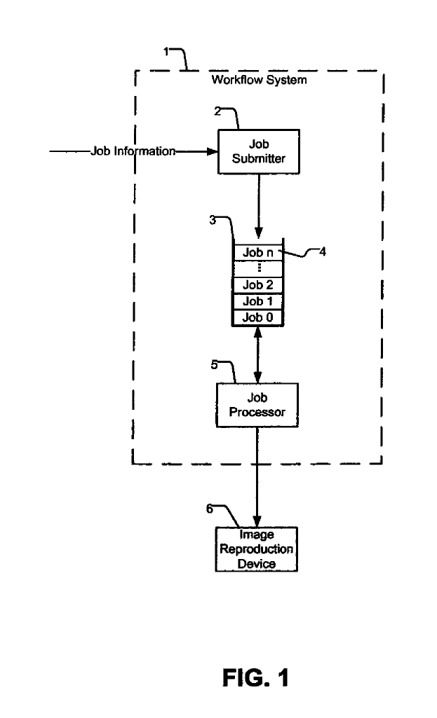

FIG. 1 is a diagram illustrating an exemplary system for producing a layout for a pressrun. Workflow system 1 is a computerized apparatus that receives job information from another system or from a user of system 1.

Job information includes, at a minimum, one or more items to be reproduced. Items can be document pages, photographs, artwork, scanned images or other information that can be rendered as an image. Original job information may explicitly include additional information about the job and/or each item or this information can be identified after receiving the original job information. As an example, additional information may include customer information, pricing information, due date information, item dimensions, desired item quantities, item color requirements, and the like.

Workflow system 1 processes the job information and produces information for image reproduction device 6. Image reproduction device 6 may be a printing press or other device capable of reproducing multiple copies of an image. Alternatively, device 6 may be a display device or hardcopy device capable of reproducing one or more copies of an image for proofing or other purposes. Any number and type of device 6 can be connected with system 1.

Workflow system 1 includes a job submitter 2 that receives original job information and allows the entry or synthesis of additional job information that may be required by workflow system 1. As an example, job priority may be synthesized from a due date or other job information or may be assigned by a user. As another example, item dimensions may be identified by reading meta-data associated with an item or by analyzing an item.

Job submitter 2 can create a job 4 that includes all of the job information necessary for workflow system 1 to process job 4. This can include the job information described above as well as other information such as processing instructions to be performed by job processor 5. As examples, job processor 5 can be instructed to convert an item to a standard format (e.g. PDF), to preflight an item, to color process an item, to include an item in a layout, and to render an item or a layout for delivery to an image reproduction device 6. Some workflow systems 1 can provide multiple job processors 5 to enable concurrent operation of job processing tasks.

Job submitter 2 can insert job 4 into queue 3 so that workflow system 1 can sequence the operation of job processing tasks efficiently. For example, multiple jobs 4 may be processed independently to the point where their items are ready to be rendered for reproduction. Workflow system 1 can then, automatically or with user assistance, generate a layout of items selected from image-ready jobs 4 that will provide an efficient pressrun for device 6. Practically, queue 4 may contain relatively few items or a large quantity of items that are image-ready. Each item may be of an arbitrary size and may have an arbitrary desired quantity.

Determining a preferred layout for one or more of these image-ready items to facilitate an efficient pressrun can be a formidable task. This is especially true when the queue includes a large number of items with varying attributes. Workflow system 1, according to the present invention, performs this task by attempting a variety of potential layouts for various sets of image-ready items. The task can be time-limited and selects a preferred layout based on a profit function that seeks to maximize pressrun efficiency.

As described above, workflow system 1 can include many job processing tasks. However, in some embodiments workflow system 1 can be limited in scope to a layout tool capable of receiving job information with items that require little or no additional processing.

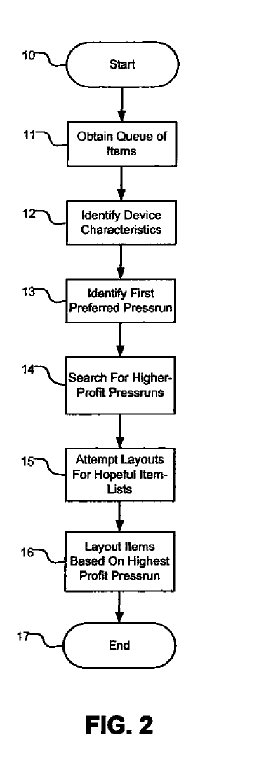

FIG. 2 is a flowchart diagram illustrating an exemplary method for identifying a preferred pressrun according to the present invention. The method begins at block 10 and proceeds to block 11 where system 1 obtains items from queue 3. Obtained items can include image-ready items from selected jobs 4. Selected jobs 4 can include all jobs or can include a subset of jobs selected by some criteria. As an example, jobs may be selected on the basis of due date, priority, paper-stock requirements, color requirements and the like.

According to one embodiment of the present invention, system 1 derives an unordered queue of item. Each item can be associated with certain information, including at least: item dimensions and desired quantity. To illustrate the present invention in the remaining description, Table 1 identifies an exemplary queue of items to be considered when determining a layout for a pressrun.

TABLE 1
Exemplary Queue of Items

| Reference | Quantity | Width | Height | Area |
|---|---|---|---|---|
| Item 0 | 800 | 252 | 144 | 36,288 |
| Item 1 | 1,500 | 792 | 432 | 342,144 |
| Item 2 | 400 | 576 | 360 | 207,360 |
| Item 3 | 400 | 504 | 144 | 72,576 |
| Item 4 | 12,000 | 504 | 360 | 181,440 |
| Item 5 | 18,000 | 252 | 144 | 36,288 |
| Item 6 | 500 | 432 | 288 | 124,416 |
| Item 7 | 200 | 504 | 360 | 181,440 |
| Item 8 | 200 | 612 | 396 | 242,352 |
| Item 9 | 10,500 | 432 | 288 | 124,416 |

For each item, a reference can be determined to identify the item. In addition, a desired quantity, width, height and computed area can be associated with each item. Other item characteristics, such as an indication of whether an item can be rotated when placed in a layout, can be included.

The method then proceeds to block 12 where system 1 identifies characteristics of image reproduction device 6. These characteristics may be determined by a user or by other means. Minimally, dimensions (height and width) of the imageable area of device 6 (e.g. press sheet) are identified. Other characteristics of device 6 can include paper stock, colorants and the like. These characteristics can be used to further limit the queue of items to be considered for the layout.

The method then proceeds to block 13 where system 1 identifies the first preferred pressrun for device 6. When used in this application, the term pressrun includes at least the following information about the reproduction process for device 6; a layout of items and a device run-length. A layout comprises an arrangement of items relative to the geometry of the press sheet to be used by device 6. A run-length specifies the number of press sheets to be reproduced by device 6.

Clearly, for layouts incorporating items having different desired quantities, different quantities of each item should be placed in a layout to increase pressrun efficiency. The terms item-set and item-list are defined for use in this application. By item-set we mean a collection of items that are considered for a layout. By item-list we mean a collection of one or more copies of each item of an item-set such that a pressrun of a given run-length for a layout of the item-list produces at least the desired quantity of each item of the item-set.

For example, “Item 0” and “Item 4” from Table 1 may be considered an item-set S=(“Item 0”, “Item 4”). Since the desired quantities for “item 0” and “Item 4” are vastly different, an efficient pressrun will include 15 copies of “tem 4” for every copy of “Item 0”. Thus, an efficient item-list I for item-set S may be 1=(“Item 0”, “Item 4”₁, “Item 4”₂, “Item 4”₃ . . . “Item 4”₁₅). An item-list can be used to identify a run-length by determining the number of press sheets required to produce at least the desired quantity of each item of the item-set.

Block 13 identifies the first preferred pressrun by attempting a variety of layouts using simple layout algorithms. A profit can be calculated for each successful layout (i.e. one that fits the sheet) and corresponding run-length and the highest profit pressrun can be retained as the first preferred pressrun. According to preferred embodiments, a substantial portion of an overall time limit can be allocated to block 13. This follows from an expectation that many layout combinations can be generated and, thus, a reasonable sampling of the search space can be explored.

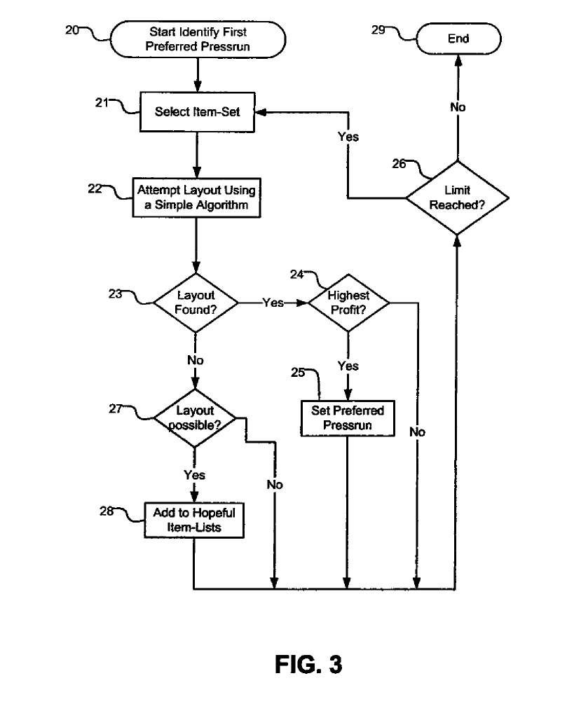

Experiments have shown that pressruns identified by block 13 can have efficient area utilization but pressrun efficiency may be lacking. FIG. 3 describes in greater detail an exemplary method for identifying the first preferred pressrun from the queue of items.

The method then proceeds to block 14 where system 1 searches for higher profit pressruns. This can be done by searching the neighborhood of selected item-sets for item-lists that have at least the potential to produce a higher profit pressrun. Block 14 may attempt a layout for an item-list using a simple layout algorithm. If no layout is generated, the possibility that a successful layout can be generated using a complex layout algorithm can be determined and if a layout is deemed possible, the item-list can be identified as a hopeful item-list.

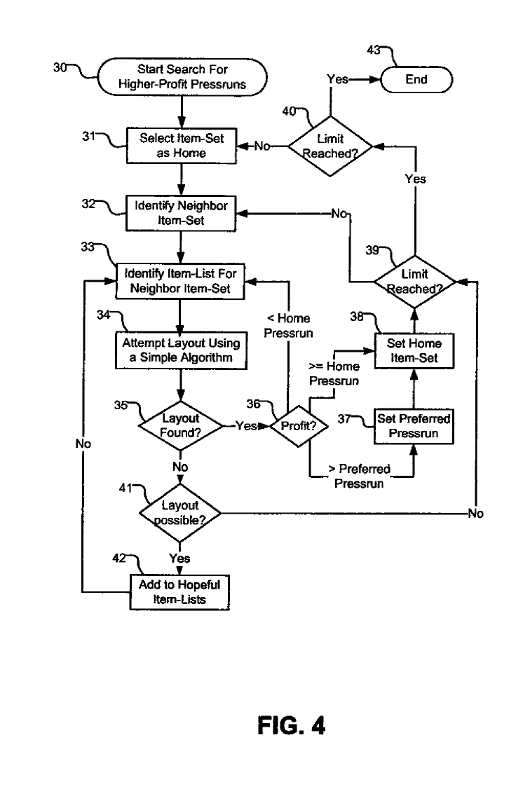

According to preferred embodiments, a substantial portion of an overall time limit can be allocated to blocks 13 and 14. In one preferred embodiment, approximately ⅔ of an overall time limit (e.g. 2 minutes) can be allocated to blocks 13 and 14 combined. FIG. 4 describes in greater detail an exemplary method for searching for higher profit pressruns.

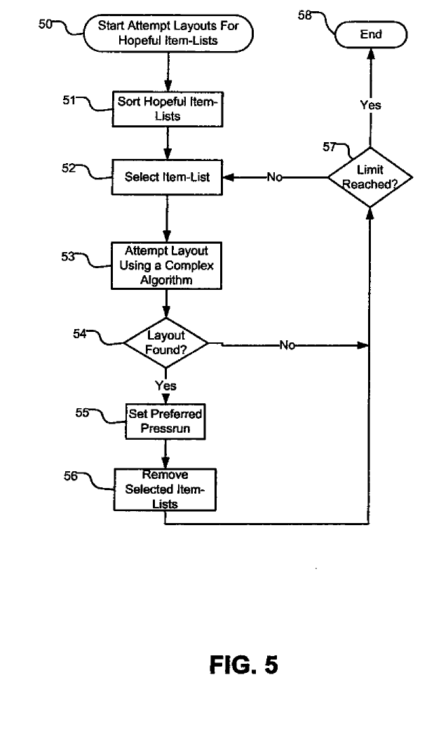

The method then proceeds to block 15 where system 1 attempts to find successful layouts for hopeful item-lists. FIG. 5 describes in greater detail an exemplary method for attempting layouts for hopeful item-lists.

The method then proceeds to block 16 where the highest profit pressrun identified can be used to generate a layout of the associated item-set. In some embodiments, the layout can be presented to a user for approval/rejection. In some embodiments, the user can also have the opportunity to edit the layout (e.g. reposition items, add/delete items). If the layout is approved, the items of the item-set can then be removed from the queue of items so that a subsequent layout can be identified by the method of FIG. 2, Alternatively, jobs 4 in queue 3 can be updated to reflect the layout of the items of the item-set so that a new queue of items can be re-generated from queue 3 to include any new jobs that may have been recently received and/or processed. Finally the method proceeds to block 17 where it ends.

FIG. 3 is a flowchart diagram illustrating an exemplary method for identifying a first preferred pressrun according to the present invention. The method of block 13 starts at block 20 and proceeds to block 21 where system 1 selects an item-set based on the queue of items. For a large queue of items, a very large number of item-sets are possible. According to one aspect of the invention, to maximize the use of the time allocated for block 13, system 1 only considers a subset of the possible item-sets for selection.

According to one embodiment, system 1 considers all item-sets of cardinality less than three. Further, for item-sets of cardinality three or larger, system 1 ranks an item-set according to a scheme that favors item-sets that are more likely to produce higher-profit layout. For example, item-sets comprising items with desired quantities that form integer ratios can be ranked very high. Further, item-sets whose desired quantities form real ratios that approach integer values can be ranked somewhat lower. Similarly, other item attributes can be used to determine item-sets that have the potential to generate higher profit.

System 1 can select an item-set at random or can use a more deterministic approach. For example, a portion of the allotted time can be used to exhaustively search the item-sets with limited cardinality. Further, a pool of highly ranked item-sets can be generated for an ordered or random search.

Upon selecting an item-set, the method proceeds to block 22 where system 1 attempts a layout using a simple layout algorithm. As described above, a selection of layout algorithms may qualify as simple based on current computing power and printing shop preferences (e.g. time limits or preferred algorithms). For example, in one preferred embodiment a simple layout algorithm will complete within one second and preferably much less than one second. System 1 may be able to identify an association between item-set characteristics and one or more qualifying simple layout algorithm. For example, a user can establish an association or system 1 can automatically determine an association.

In one preferred embodiment, system 1 can select an algorithm based on the cardinality of the item-set. In particular, item-sets with cardinality of one can be exclusively associated with a grid layout algorithm. Further, item-sets with cardinality of two can be associated with several algorithms (e.g. grid, BFDH, and Huenemann). Since these algorithms are so fast, more than one algorithm may be attempted for an item-set. Further, item-sets with cardinality of three or more can be associated with the Huenemann and/or the basic build tree algorithms. In other words, selecting a layout algorithm can be based on algorithm complexity and item-set cardinality wherein selected algorithm complexity is proportional to item-set cardinality.

Upon attempting one or more layouts for an item-set, the method proceeds to block 23 where system 1 determines if a layout was found. If a layout was found, the method proceeds to block 24. Otherwise it proceeds to block 27.

Proceeding at block 24, system 1 determines whether a new layout has a higher profit than any successful layout found by block 13. Profit can be evaluated in a number of ways. According to one embodiment a function can be used to calculate the profit of the pressrun based on the layout and associated item-set.

The profit function can employ a number of characteristics, including, for example: sheet area, press run-length, fixed press cost, per-sheet cost, item area, item copies on sheet, item desired quantity, item revenue, and item priority. Appendix A provides a source code listing for one preferred profit function embodiment. Other profit functions, perhaps customizable by a print shop, can be identified.

According to one aspect of the invention, information about each successful layout, including profit, can be saved. If a new layout has the highest profit so far, that layout and run-length can be identified as the first preferred pressrun in block 25. The method then proceeds to block 26. If a new layout does not have the highest profit so far, the method proceeds to block 26 from block 24.

Proceeding at block 26, system 1 determines if the time limit for block 13 has been reached. If not, the method proceeds to block 21 to select another item-set. Otherwise the method proceeds to block 29 where the method of block 13 ends.

Proceeding at block 27, system 1 determines if the selected item-set has a reasonable possibility of producing a layout using a complex layout algorithm. According to one embodiment, dual-feasible functions (DFF) can he used. Examples of DFF can be found in “A survey of dual-feasible functions for bin-packing problems”, by F. Clautiaux et al, which is due to be published in “Annals of Operations Research” in 2009. A DFF may identify that a layout for a sheet is unlikely for a given item-list. In this case, the method proceeds to block 26. Otherwise, the method proceeds to block 28.

Proceeding at block 28, system 1 adds the item-list to a set of hopeful item-lists and then proceeds to block 26.

FIG. 4 is a flowchart diagram illustrating an exemplary method for searching for higher-profit pressruns according to the present invention. The method of block 14 starts at block 30 and proceeds to block 31 where system 1 selects an item-set as a home item-set. A home item-set is a reference point used for searching for neighboring item-sets. According to one embodiment, item-sets are chosen from amongst a subset of possible item-sets, including item-sets corresponding to successful layouts previously identified by system 1. Item-sets can be chosen at random or based on information associated with the item-sets (e.g. highest profit).

The method then proceeds to block 32 where a neighbor of the selected item-set can be identified. A neighbor item-set can be formed by adding or removing an item from a reference item-set. According to one embodiment, identifying neighbor item-sets by adding items may be preferred. Similarly, identifying neighbor item-sets that are only one item away from a home item-set may be preferred. In other words, searching the immediate locale of many home item-sets can be preferred to searching distant neighbors of a few home item-sets. In some embodiments, the choice of whether to add or remove an item from an existing item-list can also be based on the history of item additions and removals made throughout the course of performing the method of block 14.

The method then proceeds to block 33 where an item-list corresponding to the neighbor item-set can be identified. On entry from block 32, system 1 can derive the item list, for example, by adding copies of items of the neighbor item-set to a new item-list. Items can be added, for example, in an order that seeks to reduce the run-length implied by the item-list Items can be added, for example, until the aggregate area of the item-list reaches a pre-determined limit. Through experimentation, we've found that a limit of approximately 80% is desirable. Of course, other methods can be used. For example, when a layout exists for the home item-set, the item-list can be formed by retaining the original run-length associated with the layout and adding enough copies of the added item to achieve the desired quantity of the added item.

In entry from other than block 32, block 33 can extend the existing item-list by adding one or more items from the neighbor item-set with the intent to reduce overall run-length required to yield the desired quantities of each item of the neighbor item-set. Thus, establishing an initial conservative aggregate area limit for items is not necessarily restrictive.

The method then proceeds to block 34 where system 1 can attempt a layout by using a simple layout algorithm with the item-list as an input and with an option set to terminate early if the algorithm employs iteration (e.g. terminate on first failed attempt). Next, at block 35, system 1 determines whether a successful layout was found. If successful, the method proceeds to block 36. Otherwise, the method proceeds to block 41.

Proceeding at block 36, system 1 determines the profit for the new layout. If the profit is less than the profit of the pressrun associated with the home item-set the method proceeds to block 33 where a different, and possibly more profitable, item-list may be identified. If the profit is greater than the preferred pressrun the method proceeds to block 37. If the profit is greater than or equal to the pressrun associated with the home item-set the method proceeds to block 38.

Proceeding at block 37, replaces the current preferred pressrun with a pressrun based on the newly created layout. The method then proceeds to block 38 where the neighbor item-set replaces the current home item-set. Then the method proceeds to block 39 where system 1 determines whether a limit for searching this neighborhood has been exceeded.

Through experiments, it has been found that more profitable pressruns may sometimes be found from distant neighbors of a home item-set even though layouts for intervening neighbor item-sets are not as profitable as the layout for the home item-set. Limits for extended neighborhood searches can be based on time or number of items added/removed. For example, a limit of two items added and two items removed from a home item-set selected at block 31 can be established.

Regardless of how the limit is established, if the limit is reached at block 39, the method proceeds to block 32. Otherwise, the method proceeds to block 40 where system 1 determines whether a limit has been reached for searching all home item-sets neighborhoods. If the limit has been reached, the method proceeds to block 43 where the method ends. Otherwise, the method proceeds to block 31 where a different item-set can be selected as a home item-set as the subject of another neighborhood search.

Proceeding to block 41, after a layout attempt failure, system 1 determines whether a layout is possible. As above, use of a DFF can be used. If a layout is impossible, the method proceeds to block 39. If a layout is still possible, the method proceeds to block 42 where the item-list can be added to a set of hopeful item-lists and then proceeds to block 33.

FIG. 5 is a flowchart diagram illustrating an exemplary method for attempting layouts for hopeful item-lists according to the present invention. The method of block 15 begins at block 50 and proceeds to block 51 where system 1 sorts the hopeful item-lists into a priority order since, according to some embodiments, a time limit can be established for searching the hopeful item-lists. In one preferred embodiment, approximately ⅓ of the overall time can be allocated to block 15.

According to one aspect of the present invention, sorting can be based on a computed rank that represents a tradeoff between value and difficulty. System 1 can compute a high rank for item-lists with high value and low difficulty. System 1 can compute a low rank for item-lists with low value and high difficulty.

According to one embodiment, system 1 computes rank using Equation 1.

Rank=Relative_Profit−(Relative_Area)¹⁰ (Equation 1)

Relative_Profit can be computed as the profit for an item-list normalized to the maximum profit amongst all hopeful item-lists. Similarly, Relative_Area can be computed as the aggregate item area for an item-list normalized to the available sheet area. According to another embodiment, system 1 can compute rank using Equation 2.

Rank=Relative_Profit−(DFF)¹⁰ (Equation 2)

Other ranking functions are also possible.

Having sorted the hopeful item-lists, the method proceeds to block 52 where the highest ranked remaining item-list can be selected. In some embodiments, DFF may not be computed prior to block 15 because it can be a relatively expensive computation. In this case, a first sort can be performed at block 51 using Equation 1. As each item-list is selected in block 52, DFF can be computed and the initial sort position for the selected item-list can be adjusted by comparing the new rank to the initially calculated ranks.

Next the method proceeds to block 53 where an attempt can be made to produce a layout using a complex layout algorithm. According to one aspect of the invention, a complex algorithm should have a greater chance of finding more efficient layouts than a simple algorithm. In some embodiments, a complex algorithm should have at least a 50% greater chance of finding a more efficient layout than the best simple algorithm used for an arbitrary queue of items.

One way to increase the chance of finding more efficient layouts is to evaluate more potential layouts than a simple algorithm. Other analytical methods may also be employed. Thus, a complex algorithm will likely consume more resources than a simple algorithm. In some embodiments, a complex algorithm should consume at least an order of magnitude more resources than any of the simple algorithms used. According to one preferred embodiment, a multi-phased build tree algorithm can be selected as a complex layout algorithm.

In some embodiments, the complex layout algorithm can be time limited by a pre-determined amount. For example, the time-limit can be based on a statistical measure of successful completion times for the algorithm. As another example, the time-limit can be based on the number of hopeful items-lists (e.g. aim to evaluate at least some fraction of the hopeful item-lists).

Upon completion of the layout attempt, the method proceeds to block 54 where system 1 determines if a successful layout was found. If successful, the method proceeds to block 55 where the item-list and layout replace the preferred pressrun. Otherwise the method proceeds to block 57.

Proceeding at block 56, selected item-lists are removed from the hopeful item-lists to increase efficiency of block 15. According to one embodiment, item-lists with lower profit than the preferred pressrun can be removed. According to another embodiment, item-lists whose profit does not exceed the preferred pressrun profit by more than a pre-determined amount can be removed.

Proceeding at block 57, system 1 determines if the overall time limit has been exceeded. If so, the method proceeds to block 58 and ends. Otherwise, the method proceeds to block 52 to select the next item-list.

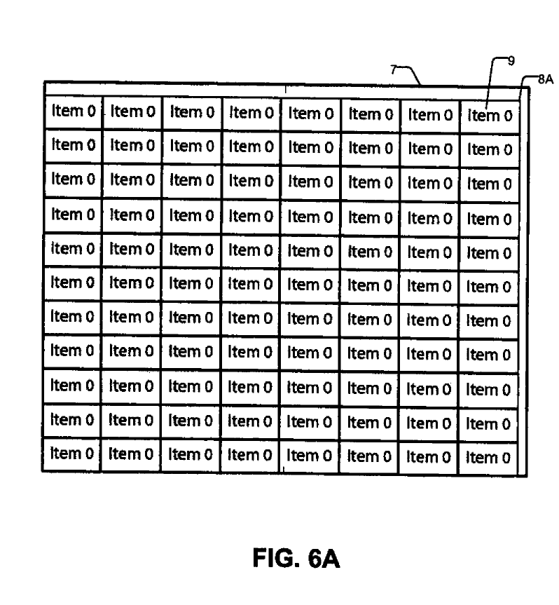

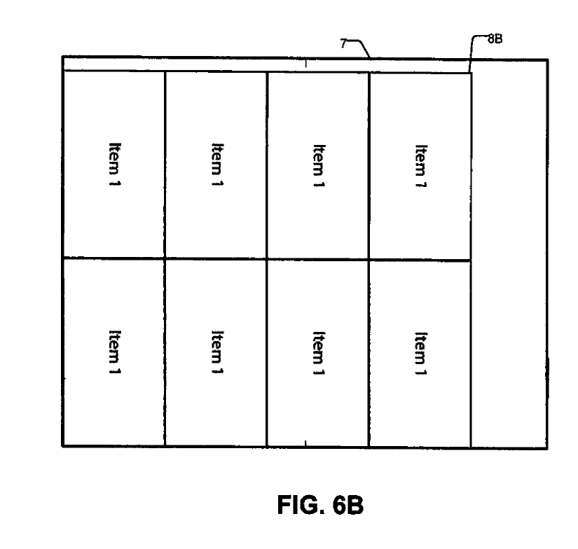

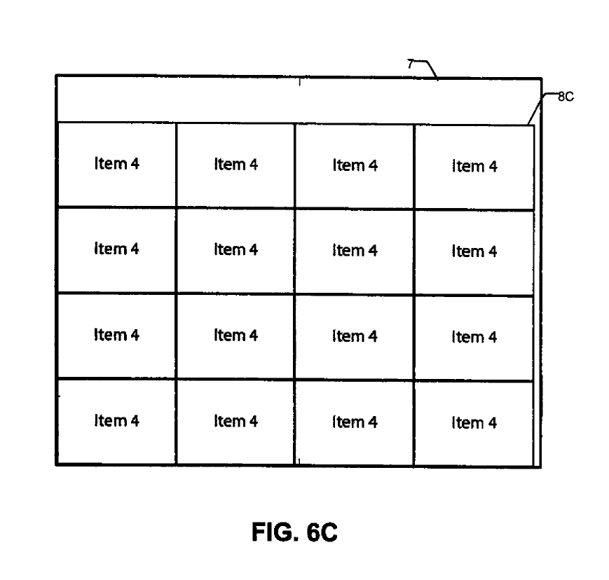

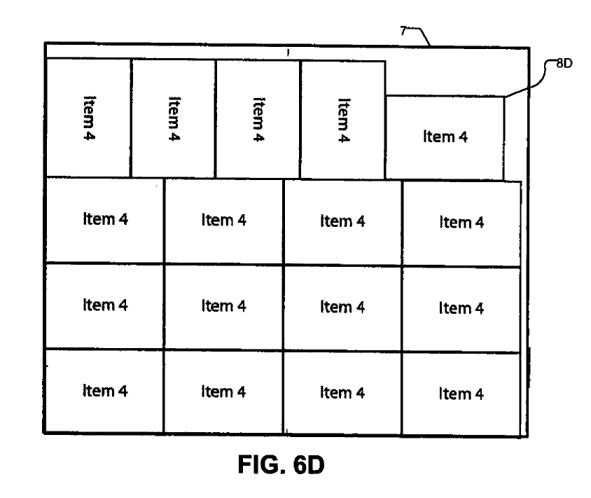

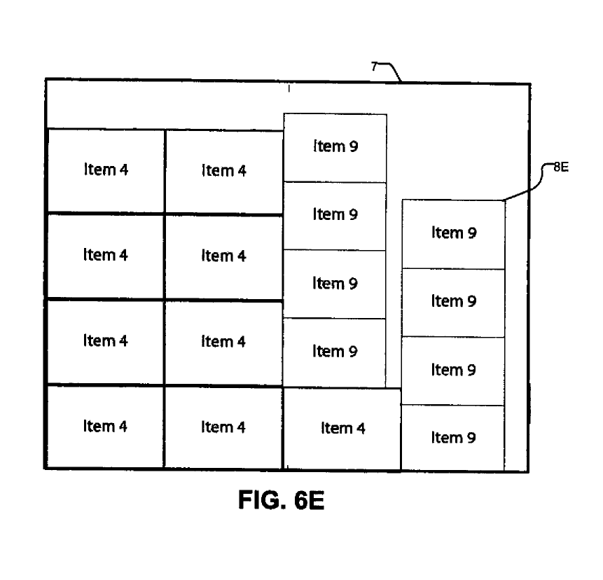

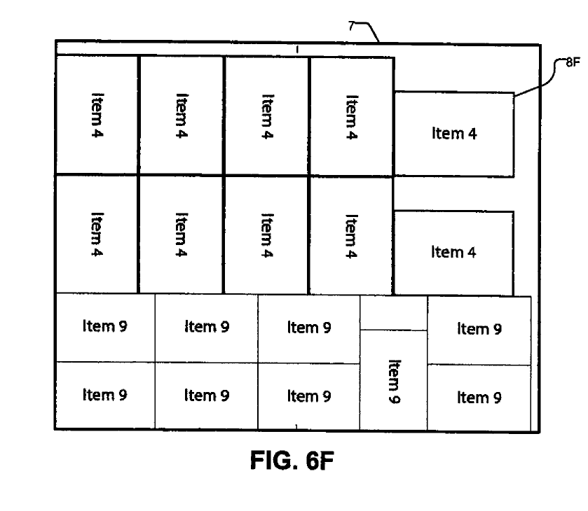

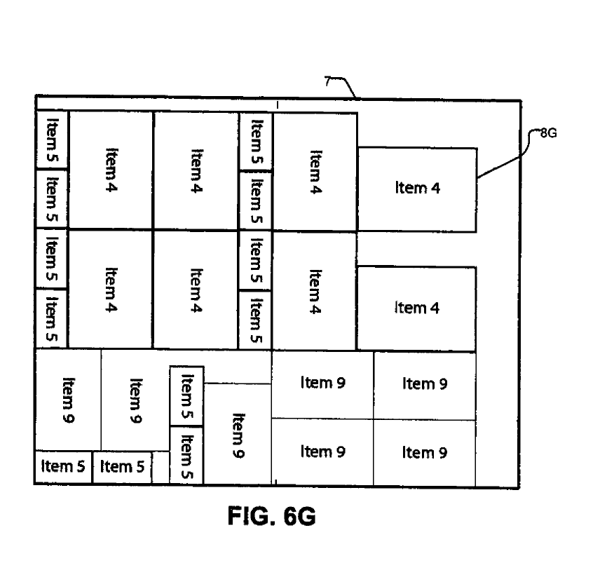

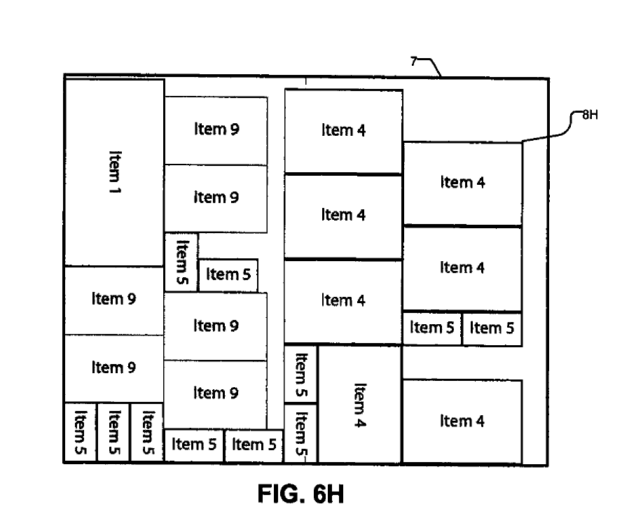

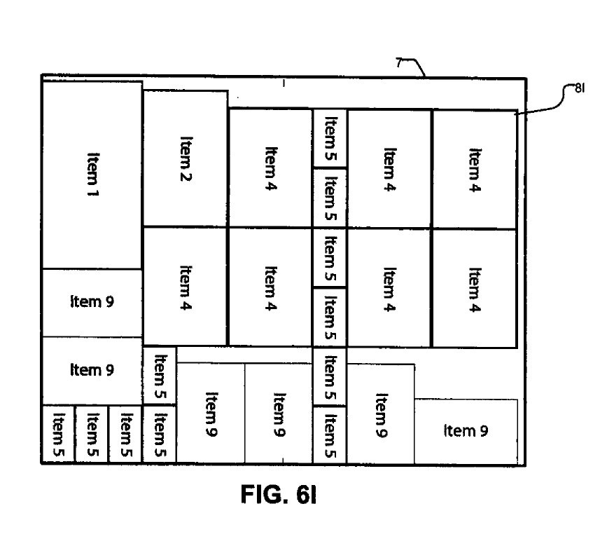

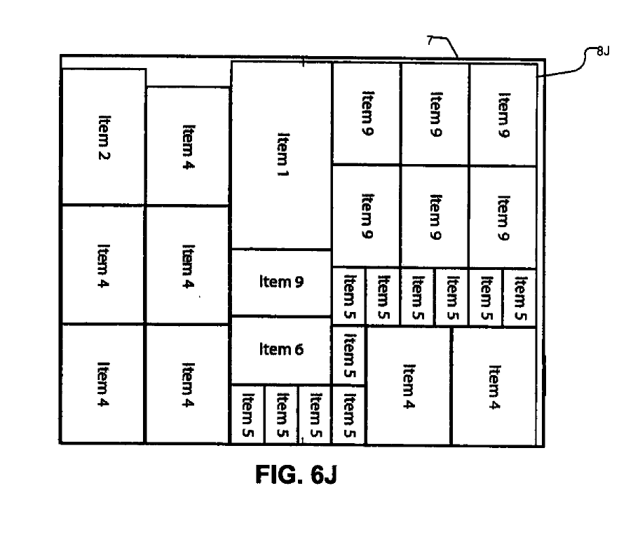

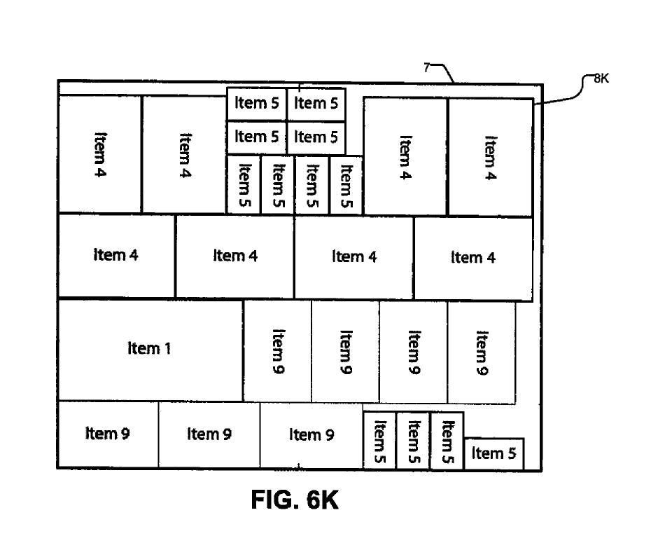

FIGS. 6A-6K are diagrams illustrating exemplary layouts generated according to the present invention. Candidate layouts illustrated in FIGS. 6A-6K are not sequentially generated layouts. Rather successive layouts correspond to candidate pressruns identified with improving profit.

These Figures were generated using a prototype embodiment of the present invention operating on the exemplary job queue of Table 1. Each diagram 10 represents a successful layout having a higher profit than the layouts of the preceding diagrams. The prototype was configured with a 180 second overall time limit and was executed on a computer, configured with the Mac OS X operating system, a 2.16 GHz Intel Core Duo CPU, and 2 GB memory.

Block 13 completed within the first second of operation and produced the layouts illustrated in FIGS. 6A-6G. During prototype testing, block 13 always completed within 8 seconds.

Block 14 completed after 154 seconds of operation and produced the layouts illustrated in FIGS. 6H-6J. Interestingly, block 14 found the best layout (FIG. 6J) after only 1 second of operation.

Block 15 started with 14 hopeful item-lists and completed after 12 seconds, having completed searches for 3 layouts. The best one found is illustrated in FIG. 6K.

FIG. 6A illustrates an exemplary first layout 8A produced for sheet 7. Layout SA was produced using a grid algorithm for an item-set comprising only one item 9 (i.e. “Item 0”). 88 copies of “Item 0” are included in layout 8A. The corresponding candidate pressrun requires a run-length of 10, producing 880 copies of “Item 0”, or 80 more than desired. The profit calculated for the candidate pressrun was −918, reflecting limited run-length despite efficient sheet coverage.

FIG. 6B illustrates an exemplary layout 8B produced for sheet 7. Layout 8B was produced using a grid algorithm for an item-set comprising only “Item 1”. 8 copies of “Item 1” are included in layout 8B. The corresponding pressrun requires a run-length of 188, producing 1,504 copies of “Item 1”, or 4 more than desired. The profit calculated for the candidate pressrun was 200, reflecting adequate sheet coverage and limited overage waste and improved run-length to make-ready ratio.

FIG. 6C illustrates an exemplary layout 8C produced for sheet 7. Layout 8C was produced using a grid algorithm for an item-set comprising only “Item 4”. 16 copies of “Item 4” are included in layout 8C. The corresponding pressrun requires a run-length of 750, producing 12,000 copies of “Item 4”, or the desired quantity. The profit calculated for the candidate pressrun was 4,545, reflecting adequate sheet coverage and no overage waste.

FIG. 6D illustrates an exemplary layout 8D produced for sheet 7. Layout 8D was produced using the basic build tree algorithm for an item-set comprising only “Item 4”. 17 copies of “Item 4” are included in layout 8D. The corresponding pressrun requires a run-length of 706, producing 12,002 copies of “Item 4”, or 2 more than the desired quantity. The profit calculated for the candidate pressrun was 4,987.

FIG. 6E illustrates an exemplary layout 8E produced for sheet 7. Layout 8E was produced using the Huenemann algorithm for an item-set comprising “Item 4” and “Item 9”. 9 copies of “Item 4” and 8 copies of item 9 are included in layout 8E. The corresponding pressrun requires a run-length of 1,334, producing 12,006 copies of “Item 4”, or 2 more than the desired quantity, and 10,672 copies of item 9, or 172 more than the desired quantity. The profit calculated for the candidate pressrun was 6,526.

FIG. 6F illustrates an exemplary layout 8F produced for sheet 7. Layout 8F was produced using the basic build tree algorithm for an item-set comprising “Item 4” and “Item 9”. 10 copies of “Item 4” and 9 copies of item 9 are included in layout 8F. The corresponding pressrun requires a run-length of 1.200, producing 12,000 copies of “Item 4”, or the desired quantity, and 10,800 copies of item 9, or 300 more than the desired quantity. The profit calculated for the candidate pressrun was 7,869.

FIG. 6G illustrates an exemplary layout 8G produced for sheet 7. Layout 8G was produced using the basic build tree algorithm for an item-set comprising “Item 4”, “Item 5”, and “Item 9”. 8 copies of “Item 4”, 12 copies of “Item 5”, and 7 copies of item 9 are included in layout 8G. The corresponding pressrun requires a run-length of 1,500, producing 12,000 copies of “Item 4”, 18,000 copies of “Item 5”, and 10,500 copies of item 9, all of the desired quantity. The profit calculated for the candidate pressrun was 8.780.

FIG. 6H illustrates an exemplary layout 8H produced for sheet 7. Layout 8H was produced using the basic build tree algorithm for an item-set comprising “Item 1” added to the item-set associated with layout 8G. One copy of “Item 1”, seven copies of “Item 4”, eleven copies of “Item 5”, and six copies of item 9 are included in layout 8H. The corresponding pressrun requires a run-length of 1750, producing 1,750 copies of “Item 1”, or 250 more than the desired quantity, 12,250 copies of “Item 4” or 250 more than the desired quantity, 19,250 copies of “Item 5”, or 1,250 more than the desired quantity, and 10,500 copies of item 9, or the desired quantity. The profit calculated for the candidate pressrun was 9,352.

FIG. 6I illustrates an exemplary layout 8I produced for sheet 7. Layout 8I was produced using the basic build tree algorithm for an item-set comprising “Item 2” added to the item-set associated with layout 8H. 1 copy of “Item 1”, 1 copy of “Item 2”, 7 copies of “Item 4”, 11 copies of “Item 5”, and 6 copies of item 9 are included in layout 8H. The corresponding pressrun requires a run-length of 1,750, producing 1,750 copies of “Item 1”, or 250 more than the desired quantity, 1,750 copies of “Item 2”, or 1,350 more than the desired quantity, 12,250 copies of “Item 4”, or 250 more than the desired quantity, 19,250 copies of “Item 5”, or 1,250 more than the desired quantity, and 10,500 copies of item 9, or the desired quantity. The profit calculated for the candidate pressrun was 9,851. FIG. 6J illustrates an exemplary layout 8J produced for sheet 7. Layout 8J was produced using the basic build tree algorithm for an item-set comprising “Item 6” added to the item-set associated with layout 8H. One copy of “Item 6”, one copy of “Item 2”, seven copies of “Item 4”, eleven copies of “Item 5”, and seven copies of item 9 are included in layout 8J. The corresponding pressrun requires a run-length of 1,715, producing 1,715 copies of “Item 1”, or 215 more than the desired quantity, 1,750 copies of “Item 2”, or 1,315 more than the desired quantity, 12,005 copies of “Item 4”, or 5 more than the desired quantity, 18,865 copies of “Item 5”, or 865 more than the desired quantity, 1,715 copies of “Item 6”, or 1,215 more than the desired quantity, and 12,005 copies of item 9, or 1,505 more than the desired quantity. The profit calculated for the candidate pressrun was 10,576.

FIG. 6K illustrates an exemplary layout 8K produced for sheet 7. Layout 8K was produced using the basic multi-phased tree algorithm for a hopeful item-list based. The hopeful item-list included one copy of “Item 1”, 8 copies of “Item 4”, twelve copies of “Item 5”, and seven copies of item 9 and produced layout 8K. The corresponding pressrun requires a run-length of 1,500, producing 1,500 copies of “Item 1”, 12,009 copies of “Item 4”, 18,000 copies of “Item 5”, and 12,000 copies of item 9, all of the desired quantity. The profit calculated for the candidate pressrun was 11,859.

Embodiments of the present invention may comprise any medium which carries a set of computer-readable signals comprising instructions which, when executed by a computer processor, cause the computer processor to execute a method of the invention. Embodiments may be in any of a wide variety of forms. Embodiments may comprise, for example, physical media such as magnetic storage media including floppy diskettes, bard disk drives, optical data storage media including CD ROMs, DVDs, electronic data storage media including ROMs, flash RAM, or the like or transmission-type media such as digital or analog communication links. The instructions may optionally be compressed and/or encrypted on the medium.

The invention has been described in detail with particular reference to certain preferred embodiments thereof, but it will be understood that variations and modifications can be effected within the scope of the invention.

### PARTS LIST

1 workflow system
2 job submitter
3 queue
4 job
5 job processor
6 image reproduction device
7 press sheet
8 layout
9 item
10 method block
11 method block
12 method block
13 method block
14 method block
15 method block
16 method block
17 method block
18 method block
20 method block
21 method block
22 method block
23 method block
24 method block
25 method block
26 method block
27 method block
28 method block
29 method block
30 method block
31 method block
32 method block
33 method block
34 method block
35 method block
36 method block
37 method block
38 method block
39 method block
40 method block
41 method block
42 method block
43 method block
50 method block
51 method block
52 method block
53 method block
54 method block
55 method block
56 method block
57 method block
57 method block

APPENDIX A
Source Code Header

```
#include “GANG_PressRunEvaluator.h”
#include <iosfwd>
#include “GANG_PrintElement.h”
class GANG_PressRunEvalMarkup : public GANG_PressRunEvaluator
{
    public:
  // constructor passing the internal parameters
  GANG_PressRunEvalMarkup
  (
    double  setupCost, // = 1000 gives the default
    double  marginCost, // = 10 gives the default
    double  minProfitPerJob = 1,
    double  minMarkupFraction = 1,
    double  maxMarkupFraction = 2
  );
  // constructor passing the cost of two different runs
  whose length ratio is 2
  GANG_PressRunEvalMarkup
  (
    int  runlengthShortestRun,// = 500 gives the default
    double  costShortestRun, // = 6000 gives the default
    double  costRunWithTwiceRunLength, // = 11000 gives the default
    double  minProfitPerJob = 1,
    double  minMarkupFraction = 1,
    double  maxMarkupFraction = 2
  );
  // constructor based on full costing model
  // we supply some default values, but it's quite reasonable to
expect significantly different values
  GANG_PressRunEvalMarkup
  (
    int  makeReadySheetCount = 100,
    int  impressionsPerHour = 10000,
    double  costPerHour = 200,
    double  costPerSheet = 10.00,
    double  minProfitPerJob = 1,
    double  minMarkupFraction = 1,
    double  maxMarkupFraction = 2
  );
  //-----------------------------------------------------------------------
  // Copy constructor. Compiler version fine.
  //
  // GANG_PressRunEvalMarkup( const
  GANG_PressRunEvalMarkup &copy );
  //-----------------------------------------------------------------------
  // Assignment operator. Compiler version fine.
  //
  // GANG_PressRunEvalMarkup &operator = ( const
GANG_PressRunEvalMarkup &rhs );
  //-----------------------------------------------------------------------
  virtual double EvaluatePressRun
  (
    const GANG_UserRequest & pressRun,
    int sequenceLength
  ) const;
  virtual void PrintParameters( std::ostream & os ) const;
  double upperBoundForQueue
  (
    const GANG_PrintElementVector & queue,
    const GANG_IntegerSize &  sheetSize,
    int  runLength
  );
  double upperBoundForQueue
  (
    const GANG_PrintElementVector & queue,
    const GANG_IntegerSize &  sheetSize
  );
  double MaxProfit
  (
    const GANG_PrintElement & job,
    const GANG_IntegerSize &  sheetSize
  ) const;
  virtual double MaxProfit
  (
    const GANG_PrintElement & job,
    const GANG_IntegerSize &  sheetSize,
    int  runLength
  ) const;
  private:
  // make the data members public so that they
  can easily be adapted from the defaults
  public:
  //private:
  // costs depend on both press and stock and sheet size
  // but the simplest model is to cost setup for the press
  // includes both paper and setup costs
  double m_setupCost;
  // and the cost to produce a sheet at the margin, i.e. one extra
sheet regardless of setup costs
  // includes both paper and press costs
  double m_costPerMarginalSheet;
  /*
  // costs depend on a variety of factors, some are press dependent
  // for this press, in typical job, how many sheets are run during make
  // ready both time and paper waste will be built into cost
  int  m_makeReadySheetCount;
  // for this press, how many sheets can be printed in an hour
  // (singled sided for single sided jobs, double sided for double sided jobs
  // in other words will compute time on press as (runLength +
makeReadySheetCount)/ impressionsPerHour
  int  m_impressionsPerHour;
  // the billable hourly rate for the press, including cost of press men
  double  m_costPerHour;
  // other costs are stock dependent
  double  m_costPerSheet;
  */
  // how much does the printer want to make if there was no markup
  double  m_minProfitPerJob;
  // for this evaluator, we're assuming a simple markup model.
We markup the cost of the paper
  // that is actually printed and shipped since we don't want to
make more money if we find a less
  // efficient way of printing the job. But we do want to make more
money when job is bigger item
  // or more instances of the tine
  // but we want it to be more worthwhile to print 2 jobs of 500
  // quantity on a sheet than it is to print 2 instances of a single
job of 1000 quantity (same size) on the same sheet
  double  m_minMarkupFraction;  // might be
more than 1, markup for very long run lengths
  double  m_maxMarkupFraction;  // must be
  more than m_minMarkupFraction; };
```

APPENDIX B
Source Code Logic

```
#include “GANG_PressRunEvalMarkup.h”
#include <algorithm>
#include <iostream>
#include <numeric>
#include <limits>
#include “GANG_PrintElement.h”
#include “GANG_Types.h”
#include “GANG_UserRequest.h”
#include “GANG_Wrappers.h”
GANG_PressRunEvalMarkup::GANG_PressRunEvalMarkup
(
  double  setupCost,
  double  marginCost,
  double  minProfitPerJob,
  double  minMarkupFraction,
  double  maxMarkupFraction
):GANG_PressRunEvaluator( ),
m_setupCost( setupCost),
m_costPerMarginalSheet( marginCost ),
m_minProfitPerJob( minProfitPerJob ),
m_minMarkupFraction( minMarkupFraction ),
m_maxMarkupFraction( maxMarkupFraction )
{
}
// constructor passing the cost of two different runs whose length ratio is 2
GANG_PressRunEvalMarkup::GANG_PressRunEvalMarkup
(
  int  runlengthShortestRun,
  double  costShortestRun,
  double  costRunWithTwiceRunLength,
  double  minProfitPerJob,
  double  minMarkupFraction,
  double  maxMarkupFraction
):GANG_PressRunEvaluator( ),
m_setupCost( 2*costShortestRun − costRunWithTwiceRunLength ),
m_costPerMarginalSheet( (costRunWithTwiceRunLength − costShortestRun) / (double)
runlengthShortestRun ),
m_minProfitPerJob( minProfitPerJob ),
m_minMarkupFraction( minMarkupFraction ),
m_maxMarkupFraction( maxMarkupFraction )
{
}
GANG_PressRunEvalMarkup::GANG_PressRunEvalMarkup
(
  int  makeReadySheetCount,
  int  impressionsPerHour,
  double  costPerHour,
  double  costPerSheet,
  double  minProfitPerJob,
  double  minMarkupFraction,
  double  maxMarkupFraction
):GANG_PressRunEvaluator( ),
m_setupCost( 0),
m_costPerMarginalSheet( 0 ),
m_minProfitPerJob( minProfitPerJob ),
m_minMarkupFraction( minMarkupFraction ),
m_maxMarkupFraction( maxMarkupFraction )
{
  m_costPerMarginalSheet = costPerSheet + costPerHour/impressionsPerHour;
  m_setupCost = m_costPerMarginalSheet * makeReadySheetCount;
}
//-----------------------------------------------------------------------
// Copy constructor. Compiler version fine.
//
// GANG_PressRunEvalMarkup( const GANG_PressRunEvalMarkup &copy );
//-----------------------------------------------------------------------
// Assignment operator. Compiler version fine.
//
// GANG_PressRunEvalMarkup &operator = ( const GANG_PressRunEvalMarkup &rhs );
//-----------------------------------------------------------------------
//virtual
double GANG_PressRunEvalMarkup::EvaluatePressRun
(
  const GANG_UserRequest & pressRun,
  int sequenceLength
) const
{
  int runLength = pressRun.GetRunLength( sequenceLength );
  double paperCost = runLength * m_costPerMarginalSheet;
  double totalCost = paperCost + m_setupCost;
  double areaPaperUsedProductively = pressRun.ProductivePaperUsage( );
  GANG_ASSERTD ( areaPaperUsedProductively > 0 );
  double costOfProductivePaper = areaPaperUsedProductively * paperCost / (runLength
* (double) pressRun.sheetSize( ).Area( ));
  double markupFraction = m_minMarkupFraction + (m_maxMarkupFraction −
m_minMarkupFraction) / runLength;
  double revenue = (1 + markupFraction) * costOfProductivePaper;
  revenue += m_minProfitPerJob * pressRun.NumPrintElements( );
  double profit = revenue − totalCost;
  //assert ( profit > 0 );
  return profit;
}
//-----------------------------------------------------------------------
//virtual
void GANG_PressRunEvalMarkup::PrintParameters( std::ostream & os ) const
{
  os << “PressRunEvalMarkup: ”
    << “setupCost = ” << m_setupCost
    << “ | costPerExtraSheet = ” << m_costPerMarginalSheet
    << “ | minProfitPerJob = ” << m_minProfitPerJob
    << “ | minMarkupFraction = ” << m_minMarkupFraction
    << “ | maxMarkupFraction = ” << m_maxMarkupFraction;
}
//-----------------------------------------------------------------------
// class used to sort print elements by their maximum profit / instance area
// Since the sort order is decreasing, returns true if lhs > rhs
// Max value for a job is m_maxMarkupFraction * amount * area + m_minProfitPerJob
// Thus profit / area is m_maxMarkupFraction * amount + m_minProfitPerJob / area
class CompareMaxProfit
{
  public:
  CompareMaxProfit( const GANG_PressRunEvalMarkup & evaluator, const
GANG_IntegerSize & sheetSize, int runLength )
  : m_evaluator( evaluator ), m_sheetSize( sheetSize ), m_runLength( runLength ) { }
  bool operator( )( const GANG_PrintElement & lhs, const GANG_PrintElement & rhs)
const
  {
    double lhsValue = m_evaluator.MaxProfit( lhs, m_sheetSize, m_runLength )
        / (double) ( lhs.NumberUpRequired(m_runLength) * lhs.Size( ).Area( ) );
    double rhsValue = m_evaluator.MaxProfit( rhs, m_sheetSize, m_runLength )
        / (double) ( rhs.NumberUpRequired(m_runLength) * rhs.Size( ).Area( ) );
    return lhsValue > rhsValue;
  }
  private:
  GANG_PressRunEvalMarkup m_evaluator;
  GANG_IntegerSize  m_sheetSize;
  int  m_runLength;
};
//-----------------------------------------------------------------------
// Max value for a job is m_maxMarkupFraction * amount * area *
m_costPerMarginalSheet / sheetArea + m_minProfitPerJob
double GANG_PressRunEvalMarkup::MaxProfit
(
  const GANG_PrintElement & job,
  const GANG_IntegerSize & sheetSize
) const
{
  double profit = (double) job.Size( ).Area( );
  profit *= m_maxMarkupFraction * job.AmountRequired( );
  profit /= (double) sheetSize.Area( );
  profit *= m_costPerMarginalSheet;
  return profit;
}
//-----------------------------------------------------------------------
double GANG_PressRunEvalMarkup::MaxProfit
(
  const GANG_PrintElement & job,
  const GANG_IntegerSize & sheetSize,
  int  runLength
) const
{
  if( job.Size( ).Area( ) * job.NumberUpRequired( runLength ) > sheetSize.Area( ) )
  {// won't fit on sheet, so assign it minus infinity as a profit
    return −std::numeric_limits< double >::max( );
  }
  double profit = MaxProfit( job, sheetSize):
  // because of no run length, the above assumed
  // use m_minMarkupFraction + (m_maxMarkupFraction − m_minMarkupFraction) /
runLength instead
  profit /= m_maxMarkupFraction;
  profit *= m_minMarkupFraction + (m_maxMarkupFraction − m_minMarkupFraction) /
runLength;
  long numGeneratedPages = runLength * job.NumberUpRequired( runLength );
  long numWasted = numGeneratedPages − job.AmountRequired( );
  double wasteCost = (double) numWasted;
  wasteCost *= job.Size( ).Area( );
  wasteCost /= (double) sheetSize.Area( );
  wasteCost *= m_costPerMarginalSheet ;
  return profit − wasteCost;
}
//-----------------------------------------------------------------------
class AccumulateInstanceCountedArea
{
  public:
  AccumulateInstanceCountedArea(int runLength) : m_runLength( runLength ){ }
  long long operator( ) ( long long previousValue, const GANG_PrintElement & nextElem
)
  {
    long long nextValue = nextElem.NumberUpRequired(m_runLength);
    nextValue *= nextElem.Size( ).Area( );
    return previousValue + nextValue;
  }
  private:
    int m_runLength;
};
//-----------------------------------------------------------------------
double GANG_PressRunEvalMarkup::upperBoundForQueue
(
  const GANG_PrintElementVector & queue,
  const GANG_IntegerSize &  sheetSize,
  int  runLength
)
{
  double upperBound = −std::numeric_limits<double>::max( );
  GANG_PrintElementVector sortedQueue( queue );
  std::sort( sortedQueue.begin( ), sortedQueue.end( ), CompareMaxProfit(*this,
sheetSize, runLength) );
  // now find the critical item
  long long areaSum = 0;
  int criticalIndex = 0;
  while (areaSum <= sheetSize.Area( ) && criticalIndex < sortedQueue.size( ) )
  {
    areaSum += sortedQueue.at( criticalIndex ).NumberUpRequired( runLength )
        * sortedQueue.at( criticalIndex ).Size( ).Area( );
    criticalIndex++;
  }
  bool allFit = true;
  if( areaSum > sheetSize.Area( ) )
  {
    criticalIndex−−;
    allFit = false;
  }
  if( allFit )
  {
    GANG_UserRequest userRequest( sortedQueue, sheetSize );
    GANG_PrintElementVector pes = userRequest.DetermineRectsToPlace( );
    upperBound = EvaluatePressRun( userRequest, pes.size( ));
  }
  else
  {
    upperBound = 0;
    for( int index = 0; index < criticalIndex; index++)
    {
      upperBound += MaxProfit( sortedQueue.at( index ), sheetSize, runLength );
    }
    areaSum = std::accumulate( sortedQueue.begin( ), sortedQueue.begin( ) +
criticalIndex,
          (long long) 0, AccumulateInstanceCountedArea(runLength) );
    double partialJobFraction = (double) (sheetSize.Area( ) − areaSum);
    partialJobFraction /= sortedQueue.at( criticalIndex ).NumberUpRequired(runLength)
        * sortedQueue.at( criticalIndex ).Size( ).Area( );
    GANG_ASSERTD( partialJobFraction <= 1.0 + kGANG_EPSILON );
    double partialJobValue = partialJobFraction * MaxProfit( sortedQueue.at(
criticalIndex ), sheetSize, runLength );
    upperBound += partialJobValue;
    upperBound −= m_setupCost;
  }
  return upperBound;
}
```

1. A method for producing a layout for a reproduction device, the method comprising:
obtaining information about a sheet to be used for a layout and a queue comprising a plurality of items to be considered for placement on the sheet wherein an item comprises item dimensions and a desired quantity;
determining a preferred pressrun for the sheet wherein a pressrun comprises a layout of items that fits the sheet and a run-length for the device and wherein determining comprises identifying a plurality of first candidate pressruns derived from the queue using an algorithm of a first type and, identifying a profit for each of the candidate pressruns;
searching for an item-list with higher profit potential than the preferred pressrun amongst neighbors of a home item-set;
wherein an item-set comprises a collection of items selected from the queue, and wherein an item-list comprises a collection of one or more copies of each item of an item-set such that a pressrun for the item-list produces at least the desired quantity of each item of the item-set;
attempting a layout for the item-list with higher profit potential using a layout algorithm of a first type; and
replacing the preferred pressrun for the sheet for a successful layout attempt.

2. A method according to claim 1 wherein a layout algorithm of the first type completes in less than a second.

3. A method according to claim 2 also comprising:
upon an unsuccessful layout attempt for the item-list with the higher profit potential than the preferred pressrun, determining whether a layout is possible for the item-list; and
adding the item-list to a set of hopeful item-lists if the layout is possible.

4. A method according to claim 3 wherein determining whether a layout is possible for the item-list comprises evaluating the item-list using a dual-feasible function.

5. A method according to claim 3 also comprising attempting a layout for an item-list of the set of hopeful item-lists wherein attempting a layout comprises using a layout algorithm of a second type.

6. A method according to claim 5 wherein attempting a layout comprises:
first ranking item-lists of the set of hopeful item-lists based on a layout value and an expected difficulty in identifying a layout; and
selecting a highly ranked item-list for the layout attempt.

7. A method according to claim 5 wherein a layout algorithm of the second type has a greater chance of finding a more efficient layout than the best layout algorithm of the first type.

8. A method according to claim 7 wherein a layout algorithm of the second type has at least 50% better chance of finding a layout for an arbitrary queue of items than the best layout algorithm of the first type used by the method.

9. A method according to claim 5 wherein a layout algorithm of the second type consumes at least an order of magnitude more resources than any algorithm of the first type used by the method.

10. A method according to claim 1 wherein identifying the plurality of first candidate pressruns comprises:
determining a plurality of item-sets;
attempting a layout using a layout algorithm of the first type;
calculating a profit and a pressrun based on a successful layout; and
saving the highest profit pressrun as the preferred pressrun.

11. A method according to claim 1 wherein a home item-set comprises an item-set corresponding to the plurality of first candidate pressruns.

12. A method according to claim 11 wherein the neighbor of a home item-set is formed by adding a different item from the queue to the home item-set.

13. A method according to claim 11 wherein the neighbor of a home item-set is formed by removing an item from the home item-set.

14. A method for producing a layout for a reproduction device, the method comprising:
identifying at least one pressrun for a sheet based on a queue of items wherein identifying comprises using a layout algorithm of a first type;
identifying a profit for the at least one pressrun;
determining if a layout is possible for an item-list having a higher profit than the at least one pressrun; and
attempting a layout for the item-list having the higher profit using a layout algorithm of a second type.

15. An apparatus for producing a layout for a reproduction device, the apparatus comprising a job processor operative to:
obtain information about a sheet to be used for a layout and a queue comprising a plurality of items to be considered for placement on the sheet wherein an item comprises item dimensions and a desired quantity;
determine a preferred pressrun for the sheet wherein a pressrun comprises a layout of items that fits the sheet and a run-length for the device and wherein determining comprises identifying a plurality of first candidate pressruns derived from the queue using an algorithm of a first type and, identifying a profit for each of the candidate pressruns;
search for an item-list with higher profit potential than the preferred pressrun amongst neighbors of a home item-set wherein an item-set comprises a collection of items selected from the queue, and wherein an item-list comprises a collection of one or more copies of each item of an item-set such that a pressrun for the item-list produces at least the desired quantity of each item of the item-set;
attempt a layout for the item-list with higher profit potential using a layout algorithm of a first type; and
replace the preferred pressrun for the sheet for a successful layout attempt.

16. An apparatus according to claim 15 also comprising an image reproduction device operative to reproduce the layout for the sheet based on the preferred pressrun.

17. An apparatus for producing a layout, the apparatus comprising a job processor operative to:
identify at least one pressrun for a sheet based on a queue of items wherein identifying comprises using a layout algorithm of a first type;
identify a profit for the at least one pressrun;
determine if a layout is possible for an item-list having a higher profit than the at least one pressrun; and
attempt a layout for the item-list having the higher profit using a layout algorithm of a second type.

18. A medium carrying a set of computer-readable signals comprising instructions and a computer system operative to access and execute said instructions wherein said instructions cause the computer system to perform the method of claim 1.
